(19) United States
(12) Patent Application Publication
(10) Pub. No.: US 2025/0288149 A1
(43) Pub. Date: Sep. 18, 2025

(54) Automated Modular Kitchen Systems

(71) Applicant: The Regents of the University of California, Oakland, CA (US)

(72) Inventors: Dennis Hong, Santa Monica, CA (US); Kyle Gillespie, Los Angeles, CA (US); Donghun Noh, Los Angeles, CA (US); Hyunwoo Nam, Beverly Hills, CA (US)

(73) Assignee: The Regents of the University of California, Oakland, CA (US)

(21) Appl. No.: 19/080,617

(22) Filed: Mar. 14, 2025

Related U.S. Application Data
(60) Provisional application No. 63/565,435, filed on Mar. 14, 2024.

(51) Int. Cl. A47J 36/32; B25J 11/00; B25J 17/02; G05B 19/042

(52) U.S. Cl. CPC A47J 36/32; B25J 11/0045; B25J 17/0283; G05B 19/0426

(57) ABSTRACT

In an embodiment of the invention, a sensor suite for an autonomous robotic kitchen system includes a thermometer, a sensor suite housing, a sensing chamber within the sensor suite housing having an intake port and an output port, at least one fan configured to control flow of gas through the sensing chamber, and a plurality of gas sensors mounted within the sensing chamber.

### CROSS-REFERENCE TO RELATED APPLICATIONS

The current application claims priority under 35 U.S.C. 119 (e) to U.S. Provisional Patent Application Ser. No. 63/565,435, entitled “Automated Modular Kitchen Systems”, filed Mar. 14, 2024. The disclosure of U.S. Provisional Patent Application Ser. No. 63/565,435 is incorporated herein by reference in its entirety.

### BACKGROUND

Automated robotic kitchen systems integrate various appliances, robotic arms, and sensors to perform cooking tasks with minimal human intervention. However, one of the primary challenges in developing such systems is the lack of a common operating software platform that seamlessly coordinates different kitchen devices. Most commercial kitchen appliances, such as ovens, stovetops, and refrigerators, operate on proprietary firmware designed for standalone use. As a result, interoperability issues arise when integrating multiple appliances into a unified robotic system. Existing smart kitchen technologies rely on fragmented software ecosystems, requiring custom middleware or application programming interfaces (APIs) to enable communication between devices. This complexity often leads to inefficiencies, increased development costs, and limited scalability for fully automated kitchen solutions.

Coordinating various appliances within a robotic kitchen also presents significant technical hurdles due to differences in control protocols, data formats, and real-time responsiveness requirements. For instance, synchronizing a robotic arm with an induction cooktop and a convection oven demands precise timing and adaptive control algorithms to account for variations in heating rates, ingredient placement, and cooking durations. Additionally, integrating vision and sensor-based feedback mechanisms to adjust cooking parameters in real time adds another layer of complexity. Without a standardized software framework, developers must create custom solutions for each combination of appliances, limiting the widespread adoption of automated kitchen systems. Overcoming these challenges requires a robust, modular software architecture that can facilitate seamless communication and dynamic task coordination among heterogeneous kitchen appliances.

### SUMMARY OF THE INVENTION

In an embodiment of the invention, a sensor suite for an autonomous robotic kitchen system includes a thermometer, a sensor suite housing, a sensing chamber within the sensor suite housing having an intake port and an output port, at least one fan configured to control flow of gas through the sensing chamber, and a plurality of gas sensors mounted within the sensing chamber.

In another embodiment of the invention, an automated robotic kitchen control system includes a plurality of appliance microcontrollers configured to receive commands directed its unique identifier and instruct an appliance according to received commands, the microcontroller including a busy status indicating whether it is ready to receive a new command, an appliance manager configured query each appliance microcontroller at regular intervals for its current status, to detect if a new appliance command is provided, and to send the new appliance command when detected to a corresponding appliance microcontroller addressed by the new appliance command when the corresponding appliance microcontroller has a busy status indicating that it is ready to receive a new command, and a scheduler configured to parse a recipe file comprising a set of appliance commands and communicate the appliance commands to the appliance manager.

In another embodiment of the invention, the appliance manager is configured to read command variables (appliance commands) and write status variables (busy status) to a shared memory, and the scheduler is configured to write command variables and read status variables from the shared memory.

Another embodiment of the invention includes a gas sensor suite, which includes a thermometer, a plurality of gas sensors mounted within a sensing chamber, an input fan configured to pull gas into the sensing chamber, and an output fan configured to expel gas out of the sensing chamber.

In another embodiment of the invention, each appliance microcontroller is assigned a unique identifier, which is reported to the appliance manager.

In another embodiment of the invention, each appliance microcontroller is configured to accept at least three commands including Read, Command, and Initialize.

Another embodiment of the invention includes supporting electronic components mounted between the sensing chamber and the sensor suite housing.

Another embodiment of the invention includes a funnel mounted to the intake port.

In another embodiment of the invention, at least one fan is mounted to the intake port.

In another embodiment of the invention, at least one fan is mounted to the output port.

In another embodiment of the invention, a multi-arm robotic manipulator for cooking, includes two or more robotic manipulator arms, each mounted to shoulder joint actuators at a stationary point at one end and to manipulator hands with wrist joint actuators at the other end, and each robotic manipulator arm having at least one joint between the two ends, the joint having an elbow joint actuator, where at least one of the joints utilizes a proprioceptive actuator and where at least one of the joints utilizes rigid linkages.

In another embodiment of the invention, the shoulder joints move in pitch and yaw directions.

In another embodiment of the invention, the elbow joints move in pitch direction.

In another embodiment of the invention, the wrist joints move in pitch and roll direction.

In another embodiment of the invention, the proprioceptive actuators utilize brushless motors.

### DESCRIPTION OF THE FIGURES

FIG. 1 illustrates an architecture for software control of an automated modular kitchen system in accordance with embodiments of the invention.

FIG. 2A illustrates internal structure of a spice dispenser in accordance with an embodiment of the invention.

FIG. 2B illustrates a rotating hub with one of eight spice dispenser modules inserted in accordance with an embodiment of the invention.

FIG. 3A illustrates an FPU in accordance with an embodiment of the invention is shown in a loaded state.

FIG. 3B illustrates an unloaded state showing locking electromagnets in accordance with an embodiment of the invention.

FIG. 4A illustrates an FPU in accordance with an embodiment of the invention with lid in place.

FIG. 4B illustrates an FPU in accordance with an embodiment of the invention with a replaceable dicing grate 414.

FIG. 5 illustrates a linkage design in accordance with an embodiment of the invention.

FIG. 6A illustrates a rotating pot appliance in accordance with an embodiment of the invention without the pot inserted.

FIG. 6B illustrates an induction compatible pot separated from the appliance portion.

FIG. 6C illustrates an arrangement of magnets in accordance with an embodiment of the invention is illustrated in.

FIG. 7A illustrates an induction pan in accordance with an embodiment of the invention is illustrated in.

FIG. 7B illustrates several induction pans stacked together in FIG. 7B.

FIG. 7C illustrates a bottom view of an induction pan with stainless-steel disk in accordance with an embodiment of the invention.

FIG. 8 illustrates a process for training a machine learning model using gas sensing data.

FIG. 9 illustrates a process for trained on sensor data to inform a cooking procedure is illustrated in.

FIG. 10A illustrates a gas sensor suite in accordance with an embodiment of the invention.

FIGS. 10B and 10C are two additional views of a gas sensor suite in accordance with further embodiments of the invention.

FIGS. 10D, 10E, and 10F illustrate a mounting apparatus in accordance embodiments of the invention.

FIG. 11A illustrates a front view, FIG. 11B illustrates a side view, and FIG. 11C top view of a manipulator arm system in accordance with an embodiment of the invention.

FIG. 12 illustrates actuators that may be utilized in accordance with embodiments of the invention.

FIG. 13 illustrates manipulators utilizing proprioceptive actuators and rigid linkages in accordance with an embodiment of the invention.

FIG. 14A illustrates an actuator in accordance with certain embodiments.

FIG. 14B illustrates an actuator in accordance with certain embodiments.

FIG. 14C illustrates a visualization of alignment testing in accordance with some embodiments of the invention.

### DETAILED DISCLOSURE OF THE INVENTION

While cooking a single dish will have a finite number of tasks and associated tools and appliances, creating a system that is capable of cooking any dish creates the daunting task of addressing a near infinite number of unique tasks. Embodiments of the invention can solve this issue through an automated modular kitchen system designed to be easily expanded with additional systems and appliances all controlled by a central command computing system. Cooking appliances and tools can be easily added and updated as necessary to increase the capabilities of the system. As will be described in greater detail below, the automated modular kitchen system can include appliances such as a spice dispenser, dicer or food processing unit, rotating pot, and tools such as an induction pan and linkage driven manipulator. Further embodiments of the invention can include a gas sensing sensor suite that can adapt a cooking process to the characteristics of gases that are detected.

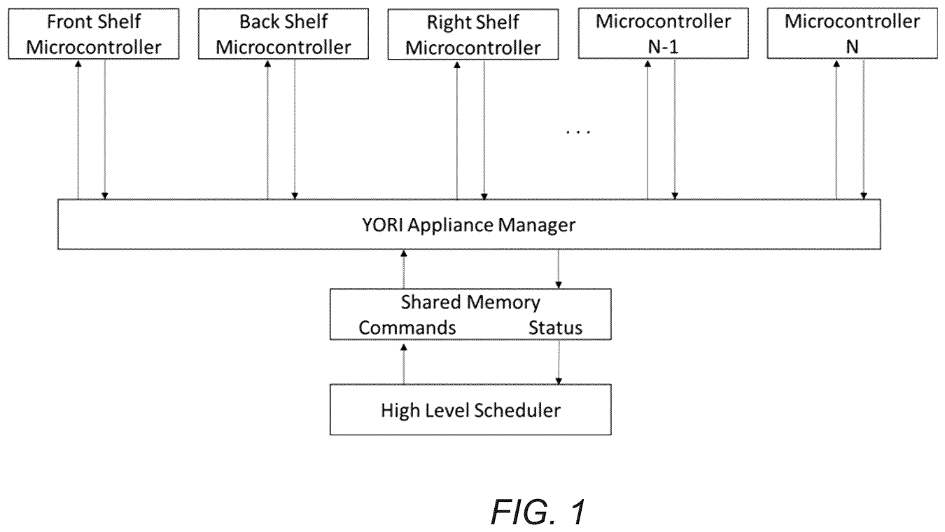

The system can accommodate the modularity of adding and removing appliances and tools through a multi-tiered appliance management system that includes local low-level controllers, a mid-level appliance manager, and a high-level scheduling system. An architecture for software control of an automated modular kitchen system is illustrated in FIG. 1.

In several embodiments of the invention, at the lowest level are all of the individual subsystem microcontrollers. These can directly control and monitor the individual appliances assigned to them. For example, the right shelf microcontroller controls and monitors the motors running the dicer and rotating pot appliances. In many embodiments, the microcontroller uses serial communication over USB to the main computer. Each microcontroller is assigned a unique identifier (ID), which it reports to the main computer when the system is initialized. This creates a kind of digital CAN bus, in which many digital connections can be managed over a single USB line that is then split at USB hubs to connect to each microcontroller individually. The system can use standardized commands such as Read, Command, and Initialize to request the current status of the attached appliances, set a new goal for a given appliance, and set up the serial connection respectively. Upon receiving a command, the microcontroller attempts to parse the received data and return a success or error message to the main computer. Each appliance has a unique set of input commands and status outputs, but common to each appliance is the Busy status, which indicates if the appliance is in use or if it is ready to accept a new command. The Busy status is primarily used by the task scheduler to determine if the current cooking task has been completed and the system is ready to receive a new command.

The appliance manager maintains the USB CAN bus connections and coordinates the transfer of data between the high-level scheduler and the microcontrollers. The system can use a shared-memory database which can be read from and written to by both the appliance manager and the high-level scheduler. The shared memory is divided into a command and a status section for each appliance. In addition to the set of commands and status variables unique to each appliance is an indicator variable if the scheduler has updated any of the command variables. In several embodiments of the invention, at regular intervals the appliance manager queries each microcontroller for the current status of all of the appliances it is associated with. This data can then be written to its corresponding memory allotment. Then it will check if the update variable for each appliance has been changed (e.g., from 0 to 1). If so, it will take the newly given command data and send it to the appropriate microcontroller. After the command has been successfully sent the appliance manager changes the shared memory variable back to 0 to indicate that the appliance command variables can be written to again by the scheduler.

At the highest level is the scheduler which parses a recipe file and communicates the associated appliance commands to the appliance manager through the shared memory buffer. In several embodiments, a recipe for the automated modular kitchen system can be defined by a series of action commands to be sent to a specific arm or appliance and a related gate condition which determines when the next step should be taken. This gate can be a timed delay, the completion of an arm trajectory, or the changing of an appliance's Busy status changing from 1 to 0 indicating a completed task. The scheduler reads and writes to the shared memory buffer in the same way as the appliance manager, but instead of reading command variables and writing to status variables it writes to command variables and reads from status variables. This interchange helps to avoid errors caused by the two systems attempting to write to the same variable simultaneously.

Although a specific architecture for an automated modular kitchen system in accordance with embodiments of the invention is described above with respect to FIG. 1, one skilled in the art will recognize that any of a variety of architectures may be utilized in accordance with embodiments of the invention. Specific appliance designs in accordance with embodiments of the invention are described next. Automated modular kitchen systems may include any or all of the appliances described below.

### Spice Dispenser

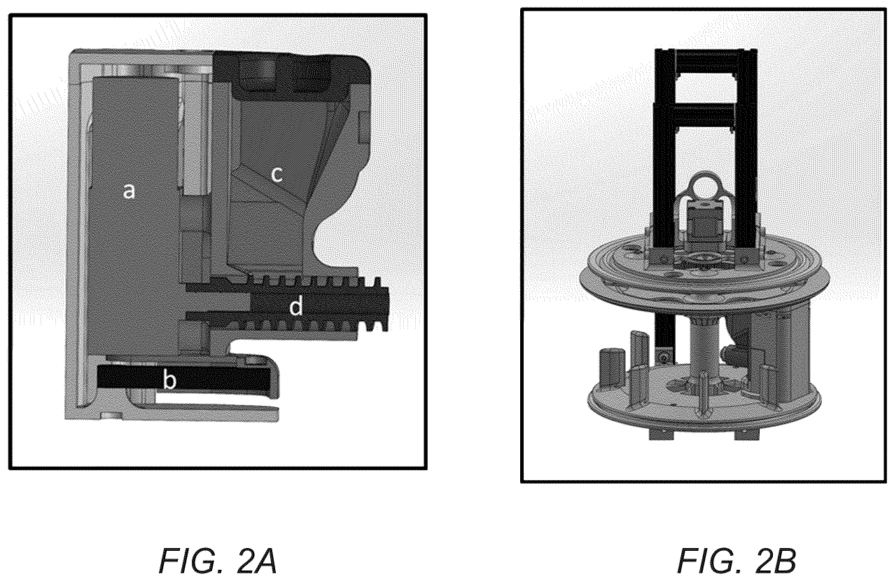

A spice dispenser in accordance with some embodiments of the invention is a modular system consisting of eight ingredient dispensing modules and a rotating hub that the modules are mounted in. FIG. 2A illustrates internal structure of a spice dispenser in accordance with an embodiment of the invention.

Each dispensing module consists of a funnel container (c) to hold the dry granular media, an archimedes screw (d) which transports said media from the funnel to the mouth of the dispenser, a geared DC (direct current) motor (a) to turn the screw, a miniature load cell (b) to measure the change in the weight of the funnel to determine how much media is being dispensed, and a printed circuit board (PCB) with a chip to read the state of the load cell and a series of magnets to connect the dispenser electrically to the rotating hub.

FIG. 2B illustrates a rotating hub with one of eight spice dispenser modules inserted in accordance with an embodiment of the invention. The rotating hub is designed to rotate 360 degrees in order to evenly spread the dispensed media over a variable target. This also allows for the automated insertion and removal of the dispenser modules using a single insertion point.

When placed into the rotating hub, the magnets on the inserted dispenser will be attracted to the magnet connector PCB located on the hub. The neodymium magnets have a metallic coating which allows them to transmit power to run the motor on the dispenser as well as I2C protocol communications to read the current weight of media that is stored in the module.

### Food Processing Unit

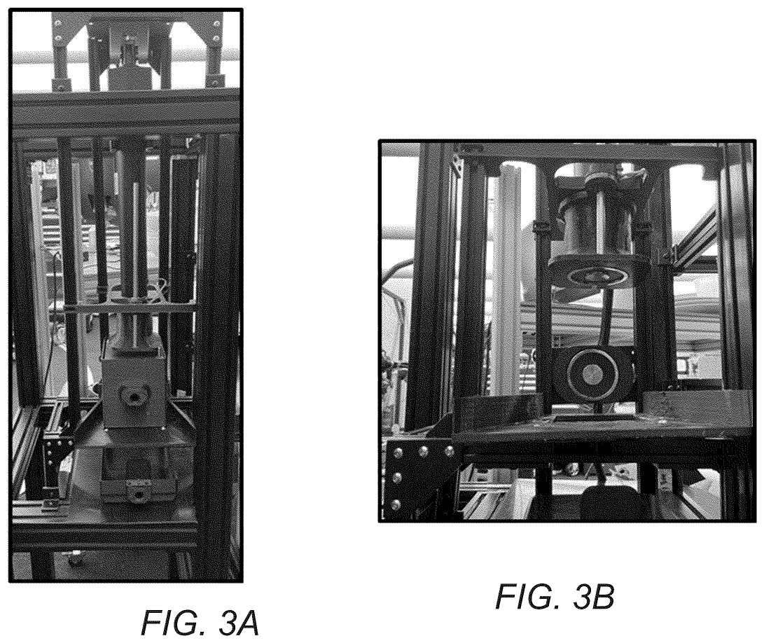

In many embodiments of the invention, a dicing food processor is designed to be a multifunctional modular food processing unit (FPU). The blades and chambers which come into contact with the ingredients are designed to be inserted into and removed from the body of the appliance. This allows for easy cleaning and repeatable alignment. An FPU in accordance with an embodiment of the invention is shown in FIG. 3A in a loaded state and in FIG. 3B in an unloaded state showing locking electromagnets.

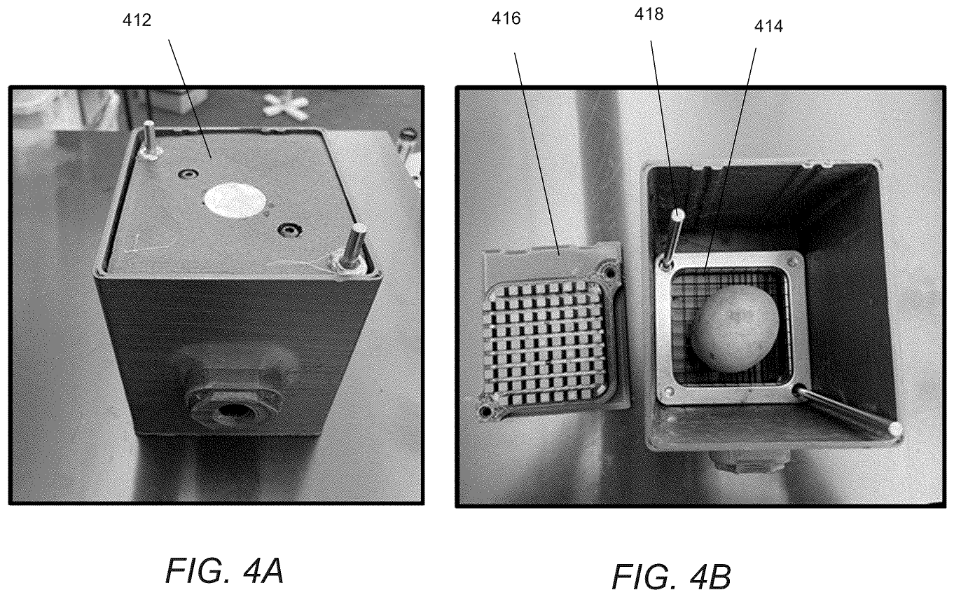

One use case of this FPU appliance is for dicing full vegetables into smaller pieces. The ingredients can be preloaded into a dicing chamber which the automated modular kitchen system can retrieve from the ingredient shelving. The chamber is then slotted into the dicer where it is locked into place by several strong electromagnets. The lid of the chamber is pressed down upon by the dicer's linear actuator and said lid is guided down precisely by several constraining rails. An FPU in accordance with an embodiment of the invention is shown in FIG. 4A with lid 412 in place and in FIG. 4B without the lid showing a replaceable dicing grate 414, pressing fingers 416, and guiding rails 418.

The modularity of this FPU appliance also allows for further capabilities. These range from simply being able to easily incorporate new dicing blade configurations in additional chambers to a more complicated use of this such as the incorporation of a food processing function to the machine. This will allow the system to finely cut and puree ingredients during the cooking process. This will share the same philosophy as the dicing function using a removable container which are preloaded with ingredients and a clean cutting blade. Once this container is placed in the device an arm will deploy a motor with attached rotation coupler to drive the blade within the container. A sealed, food safe bearing will allow for a sealed interior to keep the driving system clean and functional. The linear actuator will be used to raise and lower the lid of the food processing container to keep the ingredients in the chamber while processing and allow for easy removal when done. This can be done via a magnet embedded on the lid of the dicing/processing containers and an electromagnet attached to the linear actuator. Once the ingredients are swept out of the container the lid will be returned to the empty and dirty chamber which will then be set aside for manual cleaning.

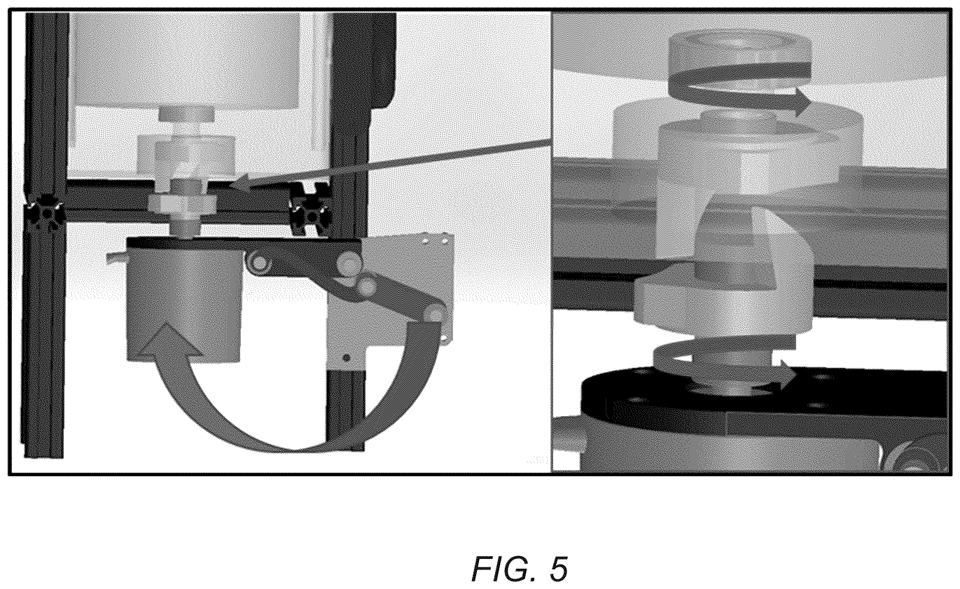

A linkage can allow the motor which will drive the food processing blades within the chamber to swing up from behind the dicer to directly underneath the chamber. A linkage design in accordance with an embodiment of the invention is illustrated in FIG. 5. Here two mating couplers can transmit the motor's rotation to the blades.

### Rotating Pot

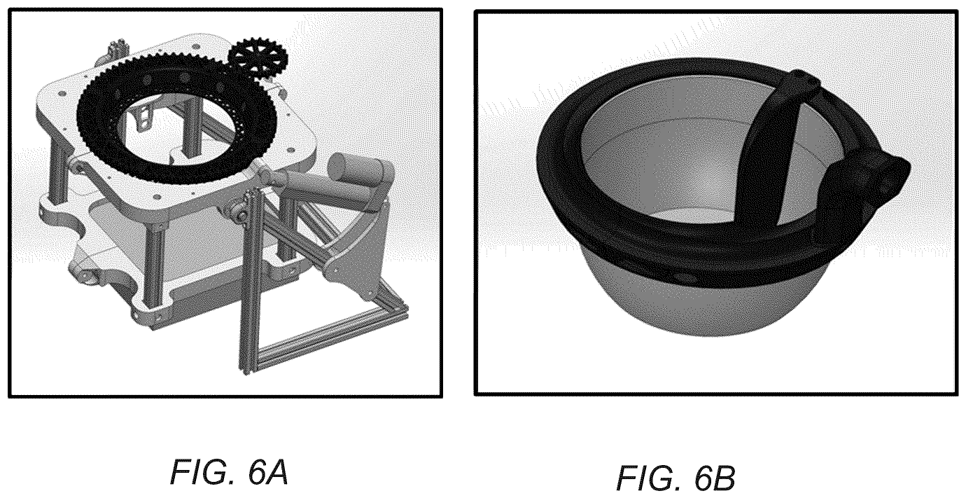

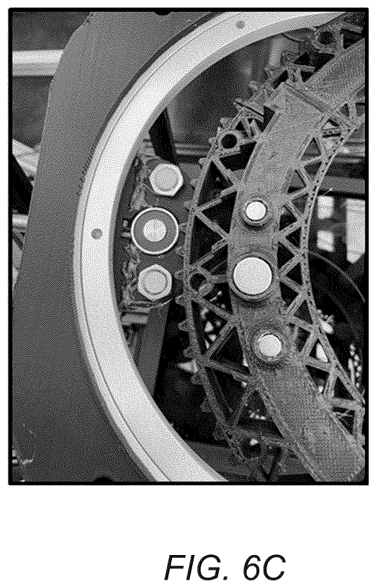

In many embodiments of the invention, a rotating pot is designed to be able to mix larger ingredients, perform coating actions such as breading, and stir fry meals. The primary difficulty this design overcomes is the ability to remove the internal cooking pot. This may utilize different pots specialized for different tasks (i.e., internal features to help mix stir fry ingredients), easier cleaning through the removal of the soiled pot, and more flexibility for transporting and transferring ingredients. A rotating pot appliance in accordance with an embodiment of the invention is illustrated in FIG. 6A without the pot inserted, and an induction compatible pot separated from the appliance portion is illustrated in FIG. 6B.

The design has two axes of rotation, one about the primary axis of the pot and the other perpendicular to it. This allows us for multiple movement patterns for different functions, such as a set angle for stir frying or a swinging motion for better mixing salads. The rotation about the pot's primary axis is indirectly driven through a gear train and interlocking magnetic components to ensure ease of insertion and removal while minimizing the potential for slipping or jamming. For repeatable loading and unloading of the removable pot, a pattern of magnets can be placed on the underside of the large rotating gear. Two of the magnets align with hall effect sensors and the third with a small electromagnet located in between them. The sensors allow for basic encoding to provide feedback on the spinning speed of the pot and also are useful for lining up the rotating pot with its initial position before unloading. The electromagnet can be charged during loading and unloading to lock the rotating gear in place. This all should ensure the rotating pot is in the optimal position to be picked up when ready. An arrangement of magnets in accordance with an embodiment of the invention is illustrated in FIG. 6C. A final sensor that may be implemented to the system is an IR heat reading sensor. This will allow for the device to report the temperature of the pot to the system without needing a piece to contact the hot and spinning pot.

### Custom Induction Pan

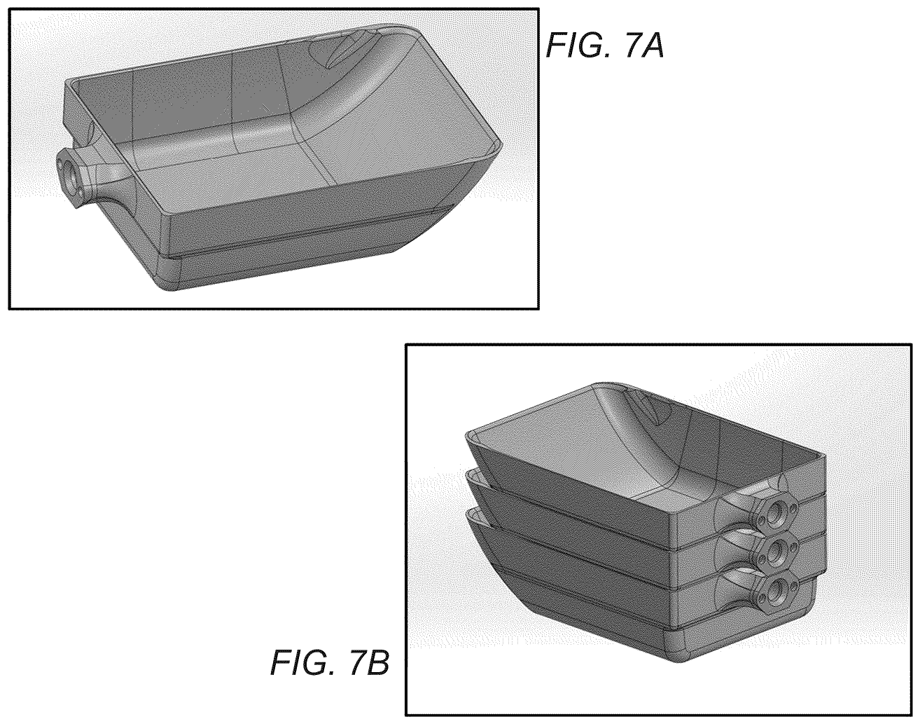

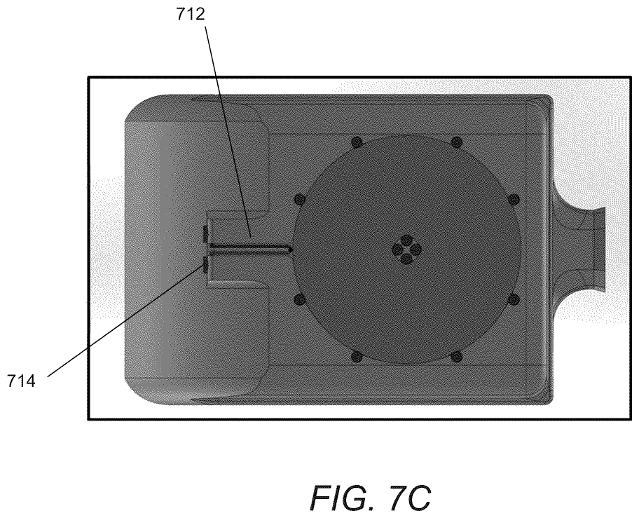

Further embodiments of the invention can include a custom induction compatible pan. An induction pan in accordance with an embodiment of the invention is illustrated in FIG. 7A and with several pans stacked together in FIG. 7B. The main body of the pan can be machined out of aluminum and designed to allow for the easy and reliable transfer of ingredients from into another pan, tool, or plate through sweeping an associated squeegee across the cooking surface and up a curved ramp on one side of the pan. Further, the shape of the pan with an internal slope and external ledge allows for the pans to be easily stacked for storage or dispensing within the automated kitchen.

On the bottom of the body of the pan, a stainless-steel disk can be mounted to allow the pan to be compatible with induction heating in accordance with several embodiments of the invention. A bottom view of an induction pan with stainless-steel disk in accordance with an embodiment of the invention is shown in FIG. 7C. The large disparity in heat expansion coefficients between the aluminum body and the stainless-steel disk means that as the pan is heated or cooled the two pieces of the pan may grow and shrink at drastically different rates. This makes adhering the two pieces together securely a difficult challenge. To account for this the design can employ two strategies. The first is the torus shape of the stainless-steel plate which is press fit into a corresponding cut out on the bottom of the pan. As the pan heats up the outer edge of the stainless-steel plate will no longer be tightly fit, but the center peg will expand into the inner ring of the torus to maintain a tight fit. When the pan is cooled the reverse will happen with the inner peg becoming loose and the outer edge becoming tight. The circular shape of the edges of the torus allow for a uniform expansion and an even distribution of stress during heating or cooling. This strategy alone though does not constrain the top face of the stainless-steel plate from being pushed out by the expansion of the bottom of the body of the pan. To solve this the stainless-steel plate can be held in place by a series of inset screws mounted along the internal and external edges of the torus. The illustrated example in FIG. 7C shows four screws at the internal edge and eight screws at the external edge.

A further feature of the pan in several embodiments is a temperature measuring docking system. The pan is designed to house a thermocouple temperature probe on the underside of the pan. The two wires of the thermocouple 712 (red and green in FIG. 7C) are mounted to two magnets 714 adhered to a notch on the front edge of the pan. Alnico magnets may be utilized for their high temperature resistance. The magnets are meant to link two corresponding magnets on a docking station to electrically connect the thermocouple on the pan to a temperature measurement system away from the pan. This allows for the system to directly measure the current temperature of the pan.

### Gas Sensing Suite

While cooking can be easily laid out in clearly defined steps, it is not uncommon for adjustments to be made during the process. Uncertainties can arise in numerous places in the cooking process. Whether it is in the quality or size and shape of ingredients or the specificities of the kitchen appliances being used, two different attempts at cooking the same recipe can produce significant changes in the quality of the resultant dish. Experienced chefs can account for these differences and adjust small parts of the recipe based on their sense of smell, touch, sight, and even hearing. Inexperienced or disabled chefs however, along with newly developed autonomous robotic cooking systems, may not have the knowhow to use these senses or have access to some of them at all. Automated modular kitchen systems in accordance with some embodiments of the invention can include a suite of gas sensing sensors that sample the gasses released during a cooking process in order to provide the system with real-time data to make smart cooking decisions.

With current sensing technologies, directly sensing aromas is possible but can be cost typically prohibitive and has had little testing in harsher environments. However, there are many economical environmental gas sensors which are tuned to be sensitive to particular aerosolized chemicals typically used for monitoring hazardous air conditions. While not in particularly hazardous quantities, these gasses are also produced during cooking processes. Due to their unique chemical makeups, each ingredient produces a unique fingerprint of gasses released over the course of their cooking process from raw to burnt. While some of these may be trivial to predict such as CO2 in smoke from a burning piece of toast, cooking meat can also produce volatile organic compounds and hydrocarbons which can be detected and measured. By measuring the gasses released over time, machine learning techniques can be used to make inferences about the doneness of a certain dish based on previously recorded data. This same method can be used for checking the quality of some ingredients. As food begins to break down, decay, and develop mold it will also begin to release different subtle gas profiles. Being able to detect food spoilage and measuring the doneness of a certain dish is vital for creating a reliable automated cooking system.

Electronic noses have been developed previously and experimented on for limited purposes. Likely either specialized for specific dishes or food spoilage of a specific ingredient but not for broader more general use. A unique experimental approach can be used with sensor fusion and intelligent data processing to create a more capable system. First, an ingredient-based profiling approach can be taken, testing individual ingredients and their interactions with each other to be able to extrapolate a predicted profile of more complex recipes without the need to train for each new individual recipe. This would vastly expand the potential usability of the system. Further, a unique set of sensors can be housed for both training models and measuring in normal use.

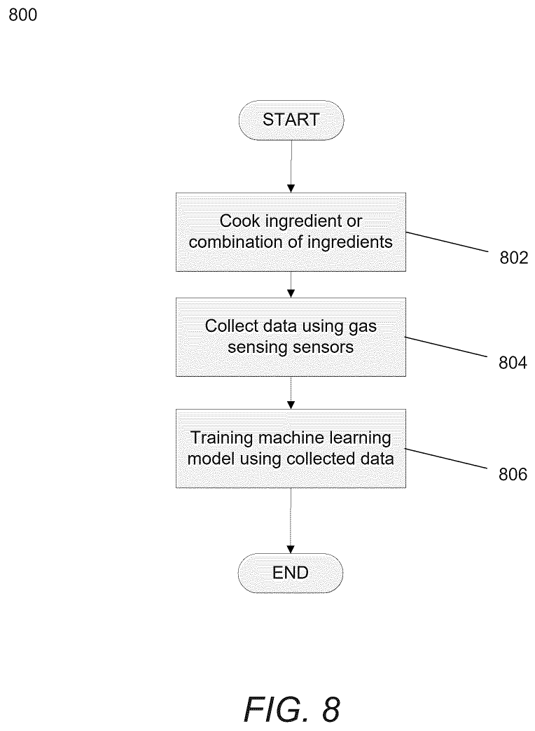

A process for training a machine learning model using gas sensing data is shown in FIG. 8. The process 800 includes cooking (802) an ingredient or a combination of ingredients. Gas may be emitted from the cooking. The process includes collecting (804) data from a gas using a suite of gas or environmental sensors such as described here. In many embodiments of the invention, the collected data is used as training data to a machine learning model to train (806) the model.

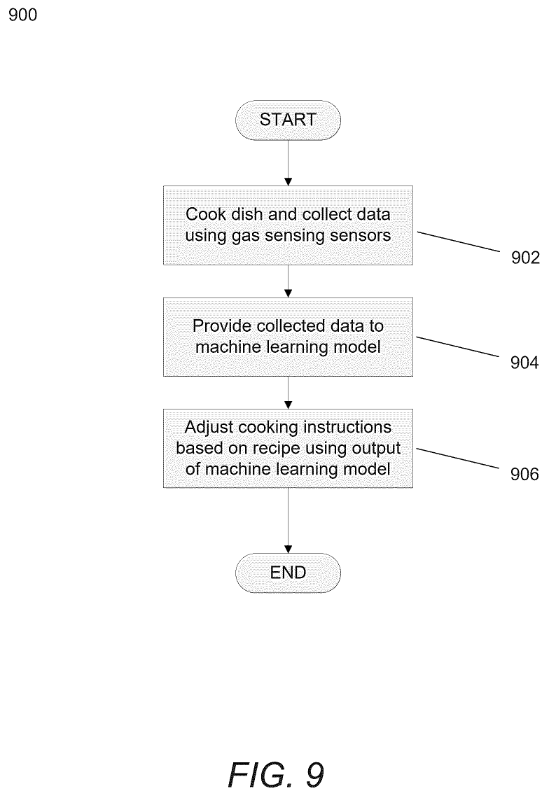

A process for using a machine learning model trained on sensor data to inform a cooking procedure is illustrated in FIG. 9. The process 900 includes cooking (902) a dish that includes one or more ingredients according to a recipe. In many embodiments, the cooking is performed by an automated modular kitchen system. Gas may be emitted from the cooking. Data from the gas is collected using a suite of gas or environmental sensors such as described here. The collected data is provided (904) to a trained machine learning model as input. In many embodiments of the invention, cooking instructions or directions to an automated modular kitchen system are adjusted (906) based on the recipe and the output of the machine learning model.

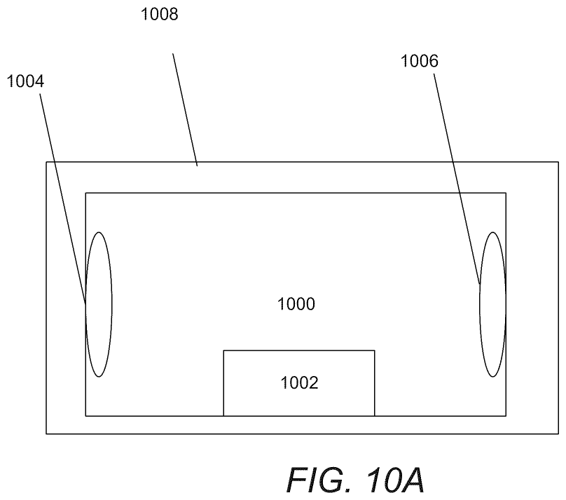

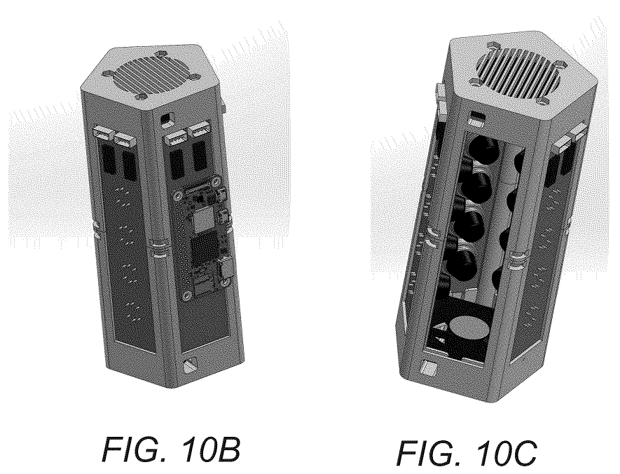

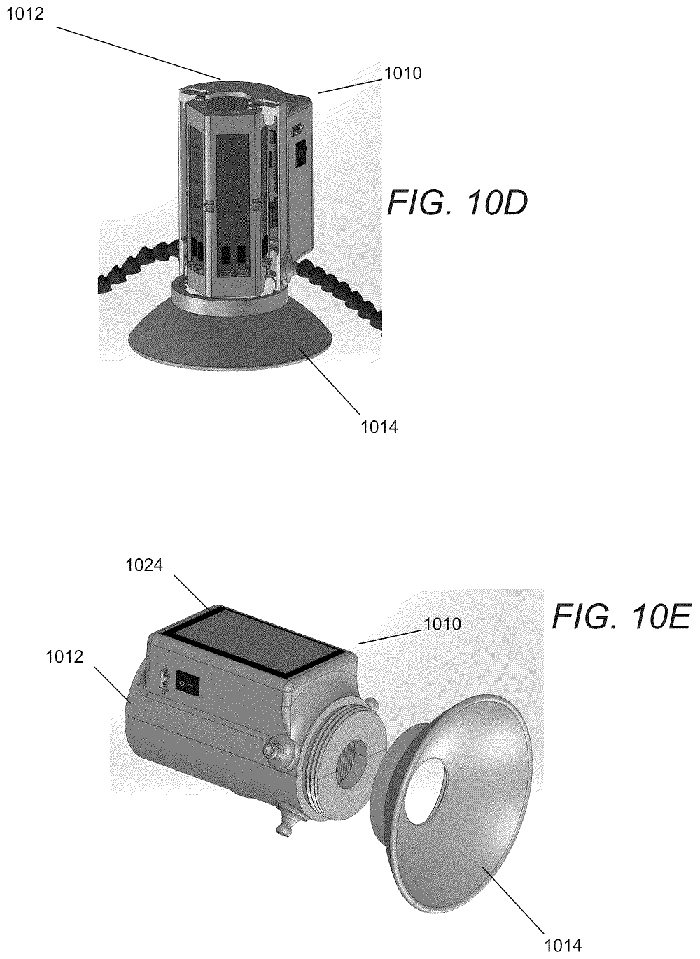

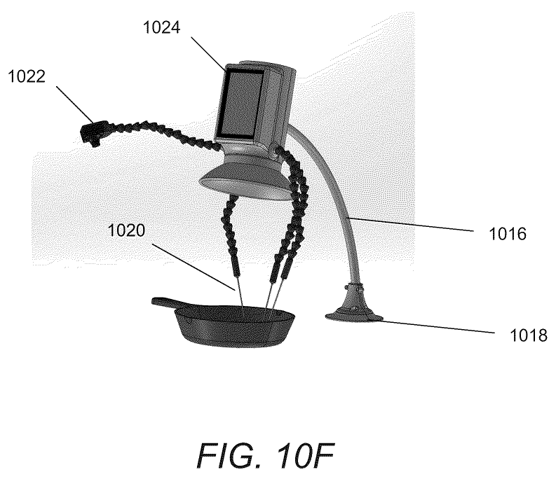

Direct temperature and camera monitoring can help create more quantitative training data sets than the more typically qualitative data sets seen in literature. In many embodiments, the gas sensing suite will be able to detect at least 21 different features including temperature, pressure, humidity, sulfur dioxide, nitrous oxide, carbon dioxide, volatile organic compounds, methane, butane, LPG, smoke, alcohol, ethanol, methane, CNG gas, hydrogen gas, carbon monoxide, ozone, hydrogen sulfide gas, ammonia, and formaldehyde. While not all of these may be useful for every ingredient or dish, having a wide range of detectable gasses provides more of an opportunity to capture unique features of a process. A gas sensor suite in accordance with an embodiment of the invention is conceptually illustrated in FIG. 10A. The sensors 1002 are mounted within a chamber 1000 of the gas sensor suite, which can also include a fan 1004 to pull gas into the sensing chamber 1000 and/or a fan 1006 to expel the gas out of the chamber 1000 after being analyzed. The chamber 1000 may be enclosed within a body or outer housing 1008. In some embodiments the sensors can be mounted on 5 separate custom PCBs. Electronics (e.g., other components of the PCBs) may be located between the chamber 1000 and the outer housing 1008. In this way, they can be shielded from the heat within the chamber 1000. FIGS. 10B and 10C are two additional views of a gas sensor suite in accordance with further embodiments of the invention.

In further embodiments, a mounting apparatus may be utilized to mount the sensor suite in a kitchen environment for model training purposes. A mounting apparatus in accordance embodiments of the invention is illustrated in FIGS. 10D, 10E, and 10F. Said apparatus 1010 can include a body section 1012 composed of two interlocking halves which constrain the sensor suite and can be locked together through screwing on a custom adapter. Pictured here is a funnel adapter 1014, which could be replaced with an adapter to attach the apparatus to a jar or container for monitoring food decomposition. In the cooking monitoring mode pictured, the body 1012 of the apparatus can be adjustably mounted in the cooking environment by attaching a flexible metal gooseneck arm 1016 with a custom designed suction cup anchor point 1018. The body 1012 of the apparatus may have a number of flexible arms surrounding the central input funnel to help easily position additional sensors such as thermocouples 1020 for localized temperature measurements or optical sensors (e.g., traditional or infrared cameras) 1022 around the cooking environment. The apparatus may utilize a touch screen 1024 to easily set up test parameters and visualize the current state of the test.

While certain components and structure of a gas sensing suite and mounting apparatus are described above, one skilled in the art will recognize that the components and structure may vary in different embodiments of the invention as appropriate to a particular application.

### Proprioceptive Linkage Driven Manipulator

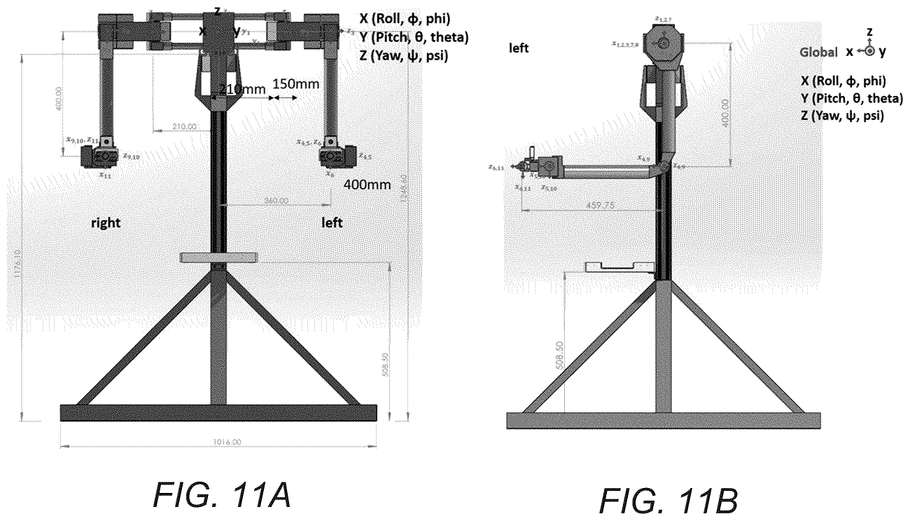

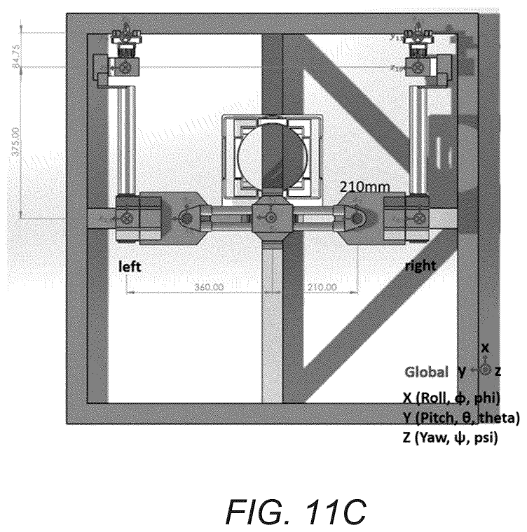

In many embodiments of the invention, one or more manipulator arms are mounted at or near the center of the automated modular kitchen system. In some embodiments, a set of two manipulator arms have at least 11 degrees of freedom (DoF), with 5 DoF on each arm and 1 DoF on the torso that rotates the direction the arms are facing. Each arm can include pitch and yaw joints at the shoulder, a single pitch joint at the elbow, and a 2 DoF wrist featuring pitch and roll joints. In some embodiments, the manipulator's specifications are tailored to achieve a human-sized cooking system. Considering the typical weight used in cooking by a person, the commensurate torque has been calculated with a target of 2 kg maximum payload when utilizing a single arm. According to this maximum payload, 37.21 Nm for the shoulder joint actuator, 17.65 Nm for the elbow joint actuator, and 2.94 Nm for the wrist joint actuator have been calculated by a static moment balance approach. The lengths of the upper arm and forearm have been set to 265.5 mm and 276.5 mm, respectively, with a shoulder link length of 350 mm, ensuring ample workspace for cooking activities. In some embodiments, carbon fiber is utilized in arm links due to its lightweight, high stiffness, and durability. In several embodiments, the manipulator stand has a total height of approximately 1300 mm, ensuring a sufficiently large workspace for the intended tasks. A manipulator arm system in accordance with an embodiment of the invention is illustrated in front view in FIG. 11A, side view in FIG. 11B, and top view in FIG. 11C. The manipulator arms can include unique features of proprioceptive actuation and the linkage transmission which bends its elbows in accordance with embodiments of the invention.

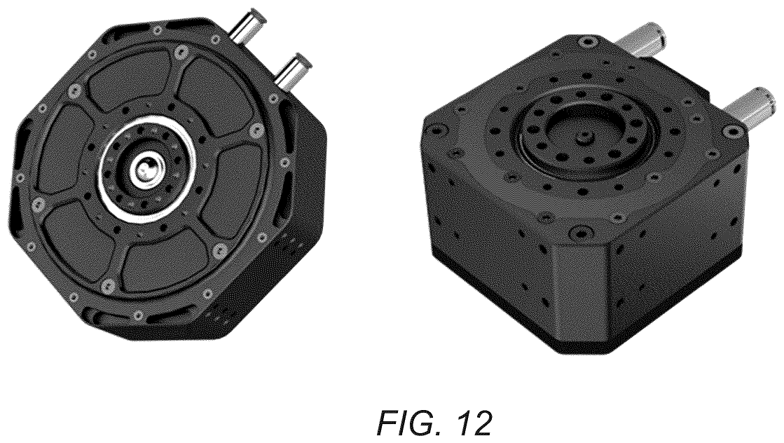

Typically, manipulator arms are driven via high geared brushed motors which are capable of producing large amounts of force, but struggle to create dynamic fluid motions and often break upon impact. This is not ideal for a cooking robot, where certain tasks such as cutting vegetables with a knife or using a mallet to tenderize meat. A manipulator arm in accordance with embodiments of the invention makes use of newly developed proprioceptive actuators such as, but not limited to, the Panda BEAR and Koala BEAR actuators from Westwood Robotics. These low geared brushless motors are able to withstand impacts and apply precise forces while still maintaining the required positional accuracy. This allows the arms to precisely incorporate force control in a way that is not replicated by other systems. Actuators that may be utilized in accordance with embodiments of the invention are shown in FIG. 12.

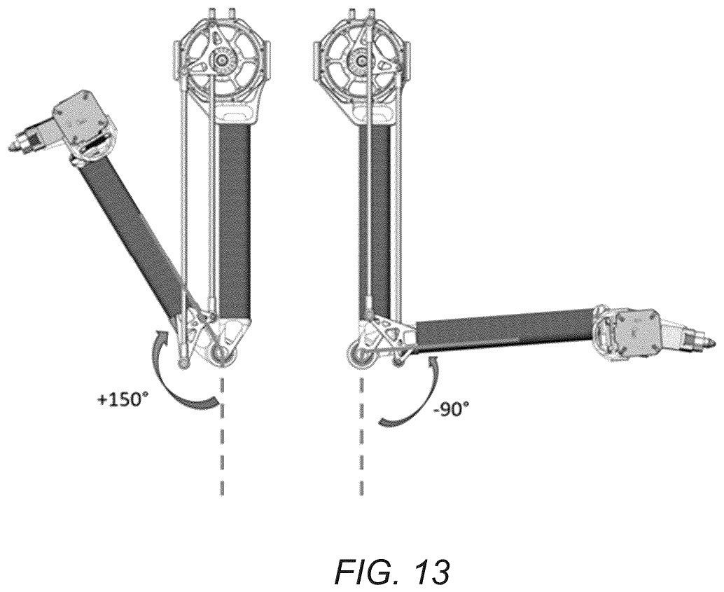

A common issue in robotic limbs is the heavy weight of their actuators weighing them down. The motors furthest from the body of the manipulator cause the most trouble due to the longer lever arm. This causes the motors further up the limb to need to work harder to support those further down and reduces the amount of force the limb can provide. This problem can be solved via positioning as many motors as close to the body of the robot as possible. Since these motors are now no longer at the joints that they move, there needs to be a transmission system to transport the rotational motion to the joints they control. Other robotic arms have used belts and pulleys or antagonistic cables to transmit the actuation. These methods come with some drawbacks, namely that the belts and cables can be difficult to tension properly causing joints to slip or introducing more friction which weakens the actuators. Another drawback is that over time the belts and cables can fail catastrophically under high force and will become stretched out causing potential inaccuracies in position and force output. Manipulators in accordance with embodiments of the invention solve this issue by using a rigid linkage system. This provides accurate reliable motion which can withstand the high forces seen during impacts. A drawback to this application can be that the joints may not be able to rotate to their fullest extent due to collisions within the linkage system. The dimensions of the linkage system in certain embodiments are designed to optimize this range of motion as much as possible. Manipulators utilizing proprioceptive actuators and rigid linkages in accordance with an embodiment of the invention are illustrated in FIG. 13.

### Tool Changing System

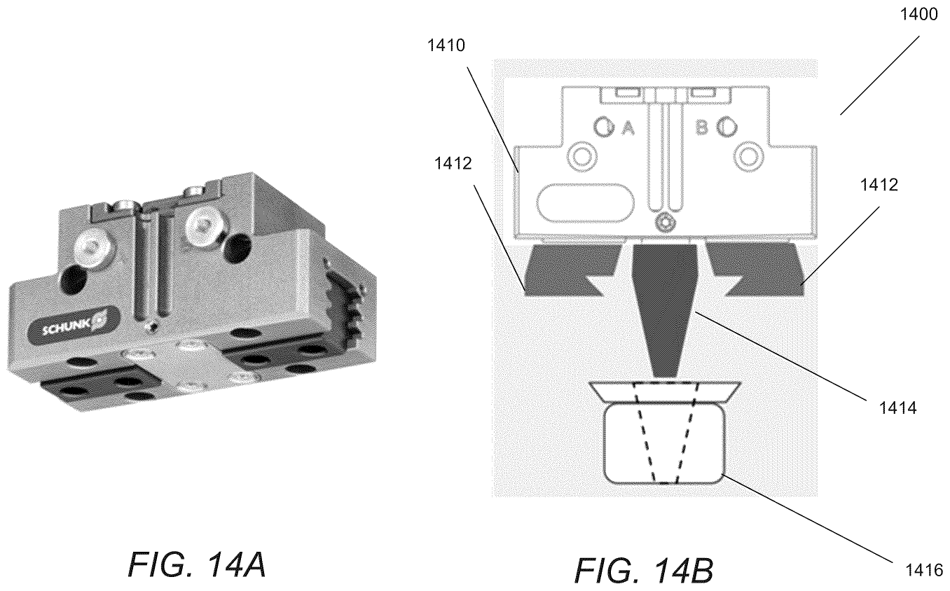

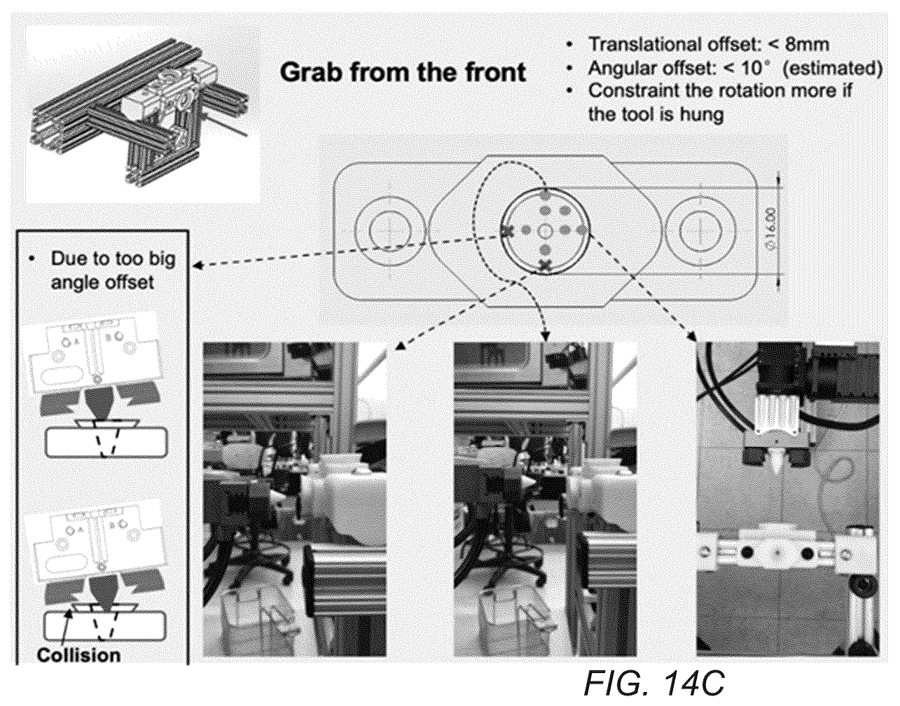

Manipulator arms in accordance with embodiments of the invention should be able to reliably grasp and release different tools and appliances. To do this, certain embodiments of the invention utilize a unique tool locking system inspired by the 5th Axis Tool Changer. In some embodiments, the tool changing system consists of an actuator (for example, a Schunk PNG Plus) which uses pneumatics to open and close our two custom locking teeth around the outside face of the custom toolplate attached to the tool or appliance to manipulate. The shape of the interlocking teeth and toolplate is carefully designed with rounded edges and an undercut which helps to pull the toolplate fully into the mechanism each time. At the center of the tool changer is a custom designed centering pin. This pin is guided into the center of a beveled hole in the middle of the tool plate. This helps to properly align the toolchanger and the toolplate. An actuator in accordance with certain embodiments is illustrated in FIG. 14A. A toolchanger 1400 according to some embodiments includes an actuator 1410, locking teeth 1412, centering pin 1414, and toolplate 1416 are illustrated in FIG. 14B. A visualization of alignment testing in accordance with some embodiments is shown in FIG. 14C.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. An automated robotic kitchen control system comprising:
a plurality of appliance microcontrollers configured to receive commands directed its unique identifier and instruct an appliance according to received commands, the microcontroller including a busy status indicating whether it is ready to receive a new command;
an appliance manager configured query each appliance microcontroller at regular intervals for its current status, to detect if a new appliance command is provided, and to send the new appliance command when detected to a corresponding appliance microcontroller addressed by the new appliance command when the corresponding appliance microcontroller has a busy status indicating that it is ready to receive a new command; and
a scheduler configured to parse a recipe file comprising a set of appliance commands and communicate the appliance commands to the appliance manager.

2. The automated robotic kitchen control system of claim 1, wherein the appliance manager is configured to read command variables (appliance commands) and write status variables (busy status) to a shared memory; and
the scheduler is configured to write command variables and read status variables from the shared memory.

3. The automated robotic kitchen control system of claim 1, further comprising a gas sensor suite, which comprises:
a thermometer;
a plurality of gas sensors mounted within a sensing chamber;
an input fan configured to pull gas into the sensing chamber; and
an output fan configured to expel gas out of the sensing chamber.

4. The automated robotic kitchen control system of claim 1, where each appliance microcontroller is assigned a unique identifier, which is reported to the appliance manager.

5. The automated robotic kitchen control system of claim 1, where each appliance microcontroller is configured to accept at least three commands including Read, Command, and Initialize.

6. A sensor suite for an autonomous robotic kitchen system, comprising:
a thermometer;
a sensor suite housing;
a sensing chamber within the sensor suite housing having an intake port and an output port;
at least one fan configured to control flow of gas through the sensing chamber; and
a plurality of gas sensors mounted within the sensing chamber.

7. The sensor suite of claim 6, further comprising:
supporting electronic components mounted between the sensing chamber and the sensor suite housing.

8. The sensor suite of claim 6, further comprising:
a funnel mounted to the intake port.

9. The sensor suite of claim 6, wherein at least one fan is mounted to the intake port.

10. The sensor suite of claim 6, wherein at least one fan is mounted to the output port.

11. A multi-arm robotic manipulator for cooking, comprising:
two or more robotic manipulator arms, each mounted to shoulder joint actuators at a stationary point at one end and to manipulator hands with wrist joint actuators at the other end, and each robotic manipulator arm having at least one joint between the two ends, the joint having an elbow joint actuator;
where at least one of the joints utilizes a proprioceptive actuator; and
where at least one of the joints utilizes rigid linkages.

12. The robotic manipulator of claim 11, where the shoulder joints move in pitch and yaw directions.

13. The robotic manipulator of claim 11, where the elbow joints move in pitch direction.

14. The robotic manipulator of claim 11, where the wrist joints move in pitch and roll direction.

15. The robotic manipulator of claim 11, where the proprioceptive actuators utilize brushless motors.
